(19) United States
(12) Patent Application Publication
(10) Pub. No.: US 2020/0162461 A1
(43) Pub. Date: May 21, 2020

(54) System and method for rapid entity role delegation

(71) Applicant: Zipwhip Inc., Seattle, WA (US)

(72) Inventors: Clay Blankinship, Seattle, WA (US); Daniel deMarteleire, Seattle, WA (US); Alan Capps, Monroe, WA (US); James Lapic, Kirkland, WA (US)

(21) Appl. No.: 16/192,652

(22) Filed: Nov. 15, 2018

(51) Int. Cl. H04L 29/06; H04L 12/58

(52) U.S. Cl. CPC H04L 63/10; H04L 51/22; H04L 63/08

(57) ABSTRACT

A method for assigning a delegate includes: receiving, from a first user, a request for authentication of the user with respect to a line; and, upon the authentication of the user being successful, controlling a user interface to display a plurality of users selectable as a delegate for the first user with respect to the line. A selection of a second user is received. The second user is assigned access to the line as the delegate for the first user. The access to the line as the delegate is carried out exclusive of credentials information of the first user. The access to the line as the delegate grants at least permission to send messages or permission to receive messages on behalf of the first user. A notification is generated to inform the second user of the assigning of the access to the line as the delegate for the first user and the delegate is enabled to access the line.

### BACKGROUND

An organization such a corporate or business entity includes users. The users may range from owners and supervisors to non-supervisory employees and members. Lines may be provided in the organization, for use by the users in sending and receiving messages. The messages may be sent, or received from, within or outside of the organization. In this regard, a user may have a role with respect to a particular line. The role specifies what actions the user can take (or cannot take) with respect to the line.

### BRIEF SUMMARY

According to at least one embodiment, a method for assigning a delegate includes: receiving, from a first user, a request for authentication of the user with respect to a line; and, upon the authentication of the user being successful, controlling a user interface to display a plurality of users selectable as a delegate for the first user with respect to the line. The method further includes: receiving, from the first user, a selection of a second user from among the plurality of users; assigning the second user access to the line as the delegate for the first user, wherein the access to the line as the delegate for the first user is carried out exclusive of credentials information of the first user, thereby removing requirement of the first user to share the credentials information. The access to the line as the delegate for the first user grants at least permission to send messages or permission to receive messages on behalf of the first user. The method further includes generating a notification to inform the second user of the assigning of the access to the line as the delegate for the first user.

According to at least another embodiment, a computing apparatus includes a processor; and a memory storing instructions that, when executed by the processor, configure the apparatus to: receive, from a first user, a request for authentication of the user with respect to a line; upon the authentication of the user being successful, control a user interface to display a plurality of users selectable as a delegate for the first user with respect to the line; receive, from the first user, a selection of a second user from among the plurality of users; assign the second user access to the line as the delegate for the first user, wherein the access to the line as the delegate for the first user is carried out exclusive of credentials information of the first user, thereby removing requirement of the first user to share the credentials information, and wherein the access to the line as the delegate for the first user grants at least permission to send messages or permission to receive messages on behalf of the first user; and generate a notification to inform the second user of the assigning of the access to the line as the delegate for the first user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram illustrating users in an organization in accordance with at least one embodiment.

FIG. 2 is a diagram illustrating a hierarchy of standard roles within an organization in accordance with at least one embodiment.

FIG. 3 is a diagram illustrating a scenario in which a user is authenticated to access one or more of multiple lines.

FIG. 4 is a diagram illustrating assigning a user as a delegate in accordance with at least one embodiment.

FIG. 5 is a diagram illustrating a system for assigning a user as a delegate, in accordance with at least one embodiment.

FIG. 6 is a flowchart of a method of assigning a delegate, in accordance with at least one embodiment.

FIG. 7 is a flowchart of a method for generating one or more menu items (e.g., a dropdown menu) to facilitate selection of an available operator as a delegate, in accordance with at least one embodiment.

FIG. 8 illustrates a simplified system in which a server and a client device are communicatively coupled via a network.

FIG. 9 is an example block diagram of a computing device that may incorporate embodiments of the present invention.

### DETAILED DESCRIPTION

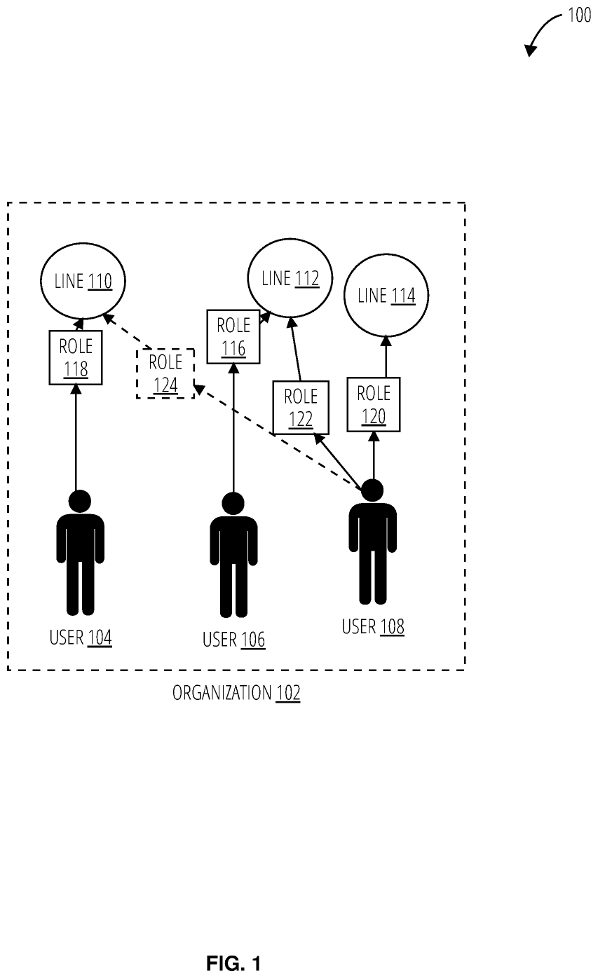

FIG. 1 is a diagram 100 illustrating users in an organization 102. According to at least one embodiment, the organization 102 may be a corporate or business entity, a government or non-profit entity, or a subset thereof (e.g., a division, sub-division, section, etc.). The organization 102 includes users, e.g., a user 104, a user 106 and a user 108. The users may include owners, managers, supervisors, employees, members, etc.

Lines (e.g., a line 110, a line 112, a line 114) are provided in the organization 102 for use by the users. According to at least one embodiment, each line is an electronic account to/from which electronic messages can be addressed/sent. The messages may include e-mail messages, text messages, or other types of messages that are capable of being electronically delivered. For example, the line 110, the line 112 and the line 114 may be text message accounts associated with particular individuals.

Each of the lines may be associated with one or more of the users. For example, a particular user may be assigned to a particular line. In this manner, the user is assigned a particular role with respect to the line.

For example, as illustrated in the diagram 100 of FIG. 1, the user 104 is assigned a role 118 with respect to (or on) the line 110. Also, the user 106 is assigned a role 116 with respect to the line 112, and the user 108 is assigned a role 120 with respect to the line 114.

As noted earlier, each of the lines may be associated with one or more of the users. With further reference to FIG. 1, the line 110 is associated not only with the user 104, but also with the user 108. In this regard, the user 108 is also assigned a role 124 with respect to the line 110. In addition, the line 112 is associated not only with the user 106, but also with the user 108. In this regard, the user 108 is also assigned a role 122 with respect to the line 112.

As such, it is understood that a user may be associated with one or more lines. For example, the user 108 is associated with line 110, line 112 and line 114.

Each of the roles (e.g., the role 116, the role 118, the role 120, the role 122, the role 124) specifies a bundle of one or more permissions. The permissions govern actions that a particular user can perform (or take) with respect to a particular line. For example, as noted earlier with reference to FIG. 1, the user 108 is assigned the role 120 with respect to the line 114, and is assigned the role 122 with respect to the line 112. In this situation, the role 120 specifies one or more permissions that govern the actions that the user 108 can perform with respect to the line 114. Also, the role 122 specifies one or more permissions that govern the actions that the user 108 can perform with respect to the line 112.

The roles (e.g., the role 116, the role 118, the role 120) may correspond to the same or different ranges of permissions. For example, via the role 120, the user 108 may have a same range of permissions with respect to the line 114 than the user 108 has via the role 124 with respect to the line 110. As another example, via the role 120, the user 108 may have a wider (or, alternatively, narrower) range of permissions with respect to the line 114 than the user 108 has via the role 122 with respect to the line 112.

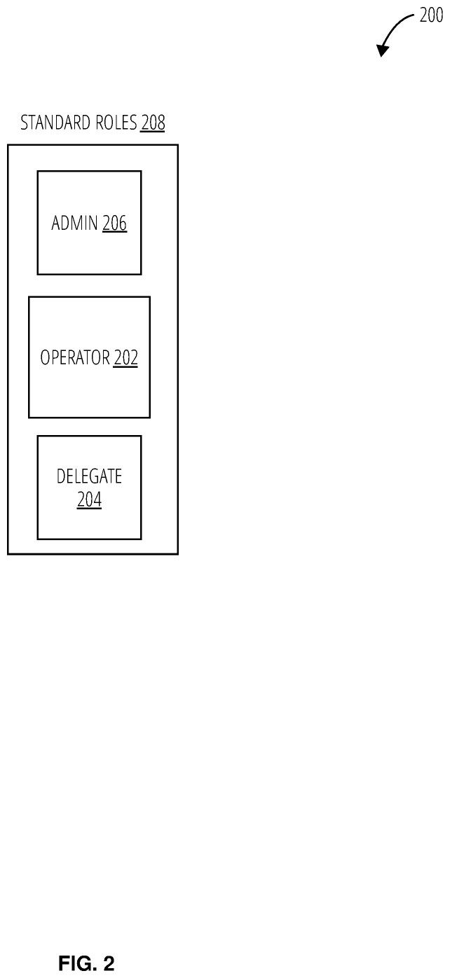

FIG. 2 is a diagram 200 illustrating a hierarchy of standard roles 208 within an organization (e.g., the organization 102).

According to at least one embodiment, the standard roles 208 include an administrator 206, an operator 202 and a delegate 204. A first user having the role of an administrator 206 on a particular line has a wider range of permissions than a second user having the role of an operator 202 on the particular line. In turn, the second user having the role of an operator 202 on the line has a wider range of permissions than a third user having the role of a delegate 204 on the line.

According to at least one embodiment, the role of an administrator 206 on a particular line has a relatively broad range of permissions, including creating other lines, adding/removing operators and/or delegates to/from the line, deleting messages sent/received at the line, and receiving messages arriving at the line.

According to at least one embodiment, the role of an operator 202 has permissions of a more narrow range than those of an administrator 206. In general, the permissions granted to the role of the operator 202 relate to the user acting as the operator 202. For example, the user acting as the operator may create and update information relating to contacts (e.g., personal contacts), may send and receive messages, and may modify operator settings (e.g., dynamic templates, password information, etc.)

According to at least one embodiment, the role of a delegate 204 has permissions pertaining to a user acting as an operator (e.g., operator 202). For example, on behalf (or in place of) a user acting as an operator, a user acting as a delegate (e.g., delegate 204) may create and update information relating to contacts, may send and receive messages, and may view (or retrieve), but not modify, operator settings. The permissions of the role of a delegate 204 may be temporary in nature. For example, the permissions may expire after a particular period of time has elapsed.

It is understood that the standard roles 208 need not be limited to the example roles illustrated in FIG. 2. As a further example, the standard roles 208 may also include a line manager (or supervisor). In addition to the permissions of an administrator 206 on a particular line, the role of a line manager may have permission to act as an administrator on one or more additional lines.

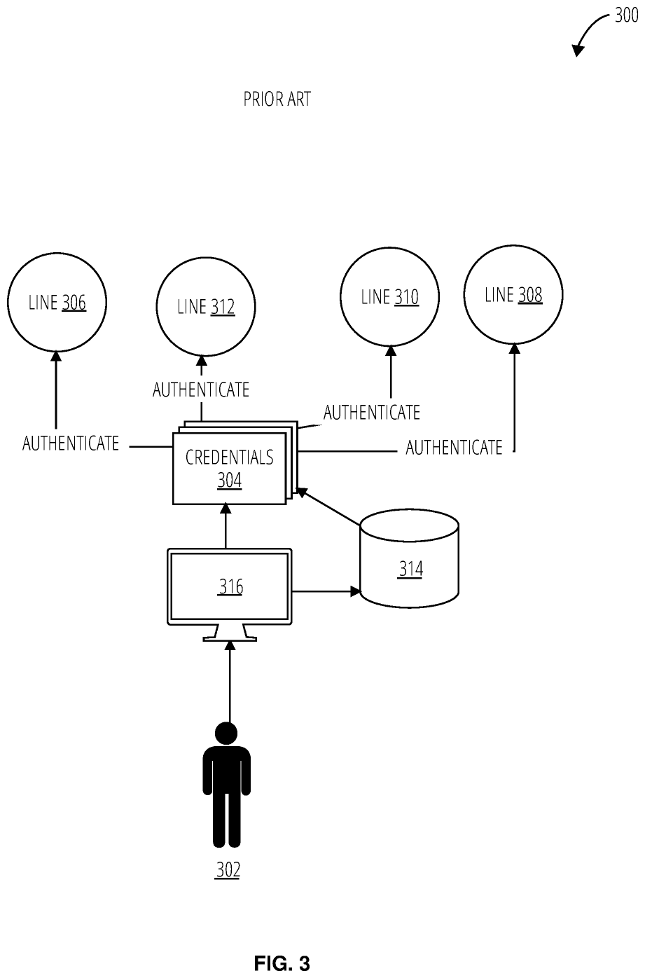

FIG. 3 is a diagram 300 illustrating a scenario in which a user 302 is authenticated to access one or more of multiple lines (e.g., a line 306, a line 312, a line 310, a line 308). In the scenario illustrated, the user 302 has been assigned the role of an operator (e.g., operator 202) on each of the multiple lines.

To access a particular one of the lines (e.g., line 306), the user 302 enter credentials 304. For example, the credentials 304 may include a login identifier (ID) and a corresponding password. The user 302 may enter the credentials 304 via a graphical user interface (GUI) (e.g., GUI 316). The entered credentials 304 are authenticated by control memory structure 314. If the credentials 304 are successfully authenticated, then the user 302 gains access to the line 306.

The user 302 may wish for another person (a second user) to have the capability to access the line 306 in place of the user 302. In this situation, the user 302 may share the credentials 304 with the second user, such that the second user is able to gain access to the line 306, in place of the user 302. As such, the second user is able to send messages via the line 306 as if the messages had been sent by the user 302. In addition, the second user is able to access messages received at the line 306 that had been intended for receipt by the user 302.

However, the capabilities of the second user are not limited to sending and receiving messages. As described earlier with reference to FIG. 2 regarding the role of an operator 202, the second user having gained access to the line 306 using the credentials 304 of the user 302 may also modify operator settings (e.g., dynamic templates, password information, etc.). In at least some situations, the user 302 may not wish for an individual such as the second user to have such modification capabilities.

Aspects of the present disclosure are directed to allowing a user serving as an operator to delegate certain capabilities to another user without requiring that the user's credentials be shared with the other user. As such, the other user may carry out the delegated capabilities exclusive of the user's credentials. In delegating some capabilities, one or more other capabilities may not be delegated. For example, the capability to modify operator settings may not be delegated to the other user.

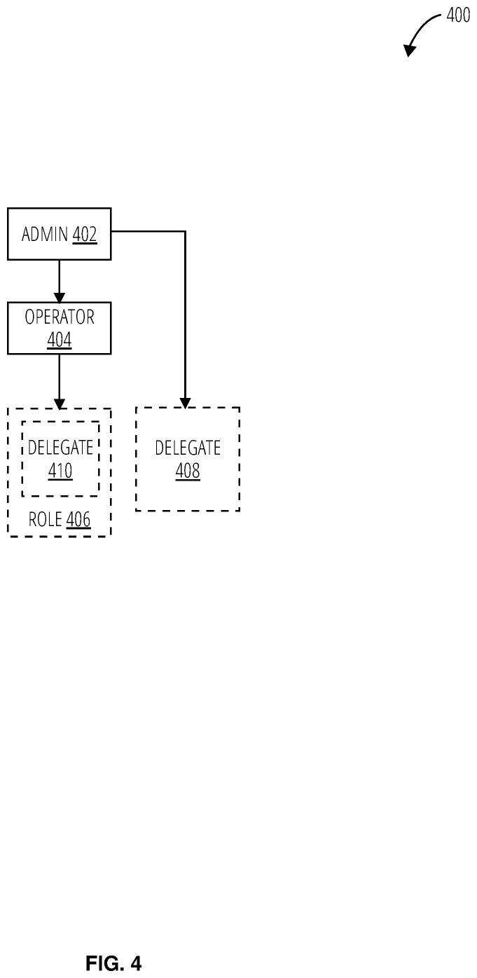

FIG. 4 is a diagram 400 illustrating assigning a user as a delegate according to at least one embodiment.

With respect to a particular line, a user serving as an administrator (e.g., administrator 402) may assign a user as a delegate 408, to perform actions on behalf of one or more other users. For example, with reference back to FIG. 1, the user 108 may serve as an administrator with respect to the line 112, and the user 106 may serve as an operator with respect to the line 112. In this situation, the user 108 may assign another user (e.g., user 104) as a delegate, to perform actions on behalf of the user 106 with respect to the line 112.

According to least one embodiment, a user who is not necessarily an administrator may assign another user as a delegate. For example, with reference to FIG. 4, a user serving as an operator (e.g., operator 404) may assign a role 406 to another user. The role 406 is that of a delegate 410, to perform actions on behalf of the user serving as the operator 404.

For example, with reference back to FIG. 1, the user 106 may serve as an operator with respect to the line 112. The user 106 is not an administrator on the line 112. Even so, the user 106 may assign another user (e.g., user 104) as a delegate, to perform actions on behalf of the user 106 with respect to the line 112.

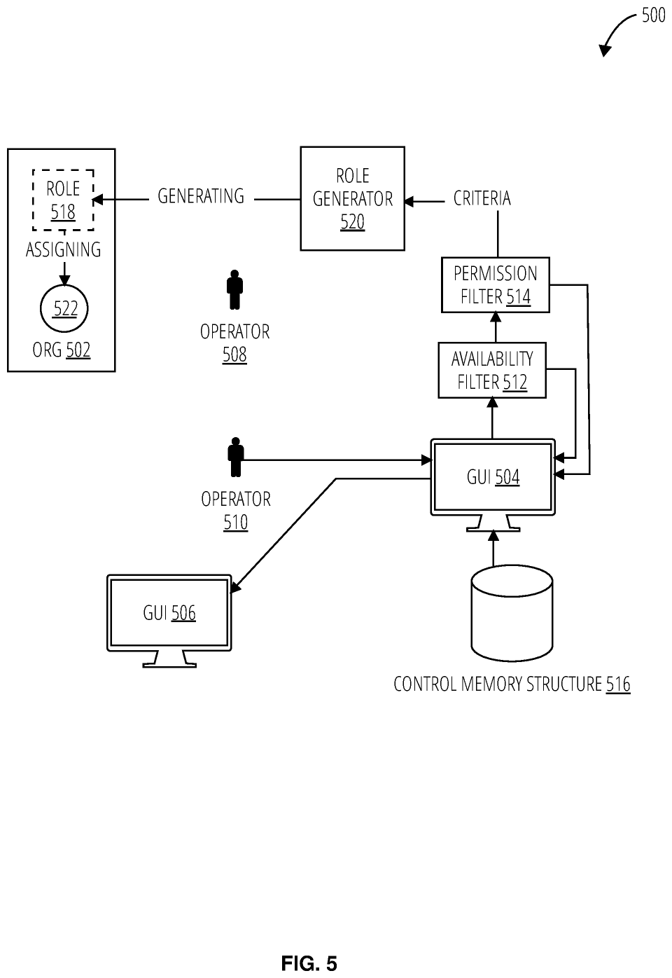

FIG. 5 illustrates a system 500 for assigning a user as a delegate according to at least one embodiment.

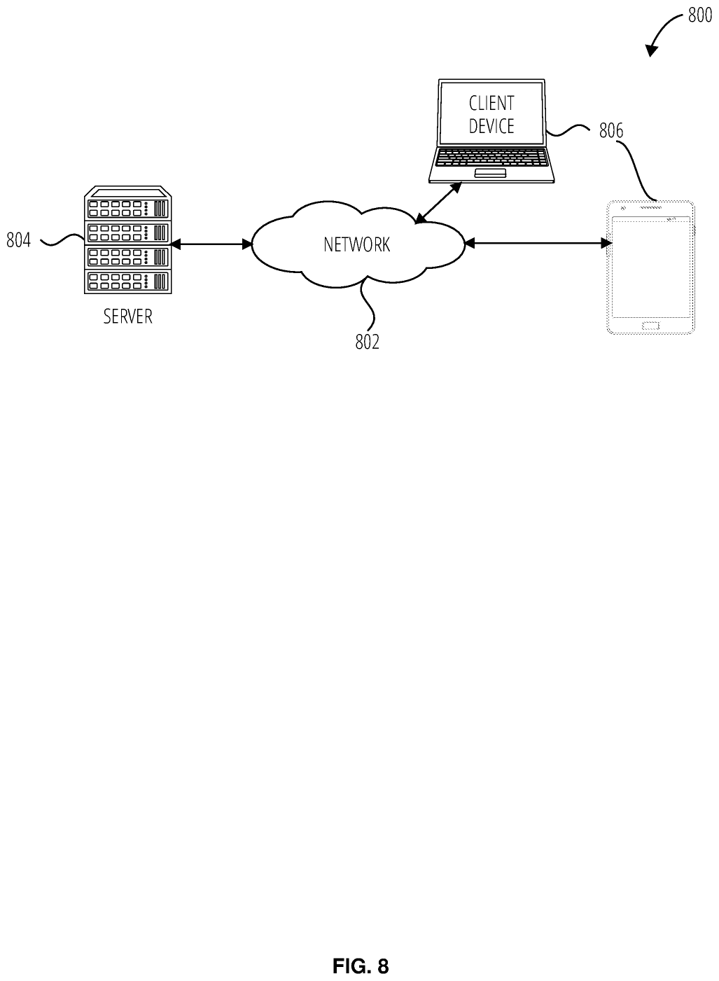

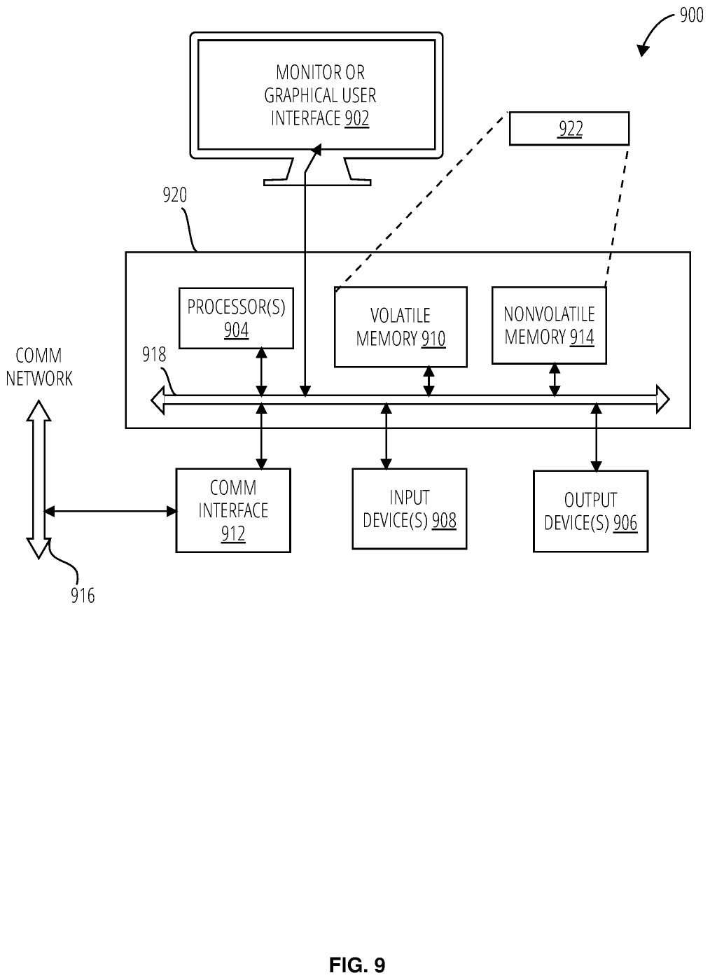

A user acts as an operator (e.g., operator 510) with respect to a line (e.g., line 522) within an organization (e.g., organization 502). As such, the user is not assigned (e.g., lacks) permission to perform one or more actions that are performed by an administrator with respect to the line 522. One or more GUIs (e.g., GUI 504, GUI 506) are available for use by the operator 510. Each of the GUIs may be included in (or coupled with) a client device 806, which will be described in more detail later with reference to FIG. 8 and FIG. 9.

To gain access to the line 522, the operator 510 enters credentials (e.g., credentials 304) via one of the GUIs. For example, the operator 510 enters the credentials via GUI 504. Credentials entered by the operator 510 are authenticated. For example, the credentials are authenticated by a control memory structure 516, which may be included in (or coupled with) a server 804, which will be described in more detail later with reference to FIG. 8 and FIG. 9. Once the credentials entered are successfully authenticated, the operator 510 gains access to the line 522.

The operator 510 may then choose to modify his user settings, which include assignation of a delegate to act on his behalf. When the operator 510 chooses to assign such a delegate, one or more items (e.g., menu items) are displayed at the GUI 504 to facilitate selection of an available operator as a delegate. According to at least one embodiment, a dropdown menu is displayed at the GUI 504. The dropdown menu lists operators, from which the operator 510 may select in assigning a delegate.

The listed operators may include one or more operators that have permission to serve as a delegate for the operator 510. The operators that have such permission are deemed available to serve as a delegate for the operator 510. According to at least one embodiment, the operators that are deemed to be available may have been successfully passed by one or more filters (e.g., availability filter 512, permission filter 514). The filters may be implemented in (or by) the server 804 of FIG. 8. The availability filter 512 filters out operators who are already assigned to the line. As such, an operator who is not already assigned to the line is passed by the availability filter 512. The permission filter 514 filters out operators whose accounts are suspended. As such, an operator whose account is not suspended (e.g., is active) is passed by the permission filter 514. According to at least one embodiment, if a particular operator is successfully passed by both the availability filter 512 and the permission filter 514, the operator is deemed to be available, and is included in the listing of available operators.

As noted earlier, the operator 510 may select one of the operators displayed in the dropdown menu, in assigning a delegate. As illustrated in FIG. 5, the operator 510 may select to assign an operator 508 as the delegate.

The role generator 520 generates a role 518 for the selected operator 508 as a delegate for the operator 510. The role generator 520 may be implemented in the server 804 of FIG. 8. Functions for assigning the selected operator 508 as a delegate with respect to the line 522 are then executed. For example, an application program interface (API) call may be executed to assign the selected operator 508 as a delegate. According to at least one embodiment, the delegate for the operator 510 is granted fewer than all of the permissions that were granted to the operator 510. For example, the delegate for the operator 510 is not granted permission to modify operator settings of the operator 510.

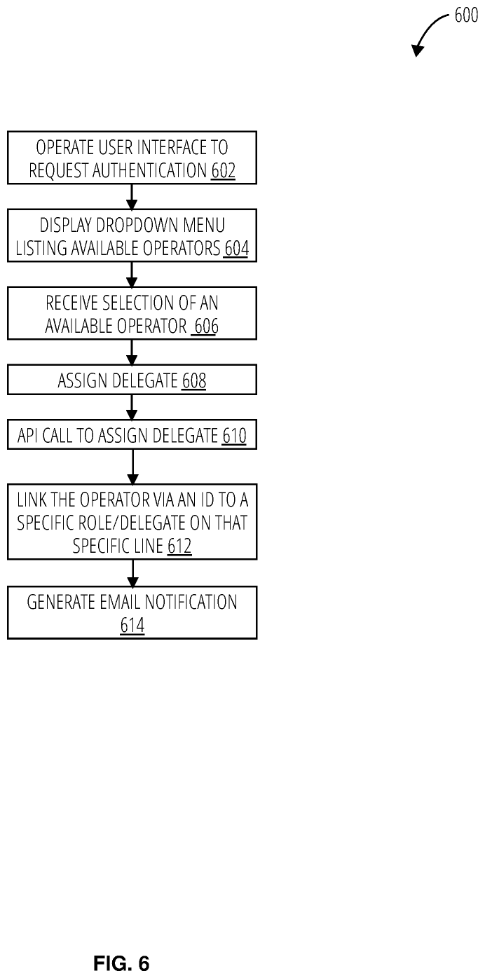

FIG. 6 is a flowchart of a method 600 of assigning a delegate, according to at least one embodiment.

With reference to block 602, a user operates a user interface to request authentication. For example, as illustrated in FIG. 5, the operator 510 enters credentials via GUI 504 to request authentication for access to the line 522.

With reference to block 604, upon the authentication being successful, the user interface displays a menu listing users that are selectable as a delegate for the user with respect to the line. For example, a dropdown menu listing available operators is displayed. As was described earlier with reference to FIG. 5, one or more items (e.g., menu items) are displayed at the GUI 504 to facilitate selection of an available operator as a delegate. For example, a dropdown menu is displayed at the GUI 504.

With reference to block 606, a selection of an available operator is received. For example, as was described earlier with reference to FIG. 5, the operator 510 may select to assign an operator 508 as the delegate.

With reference to block 608, the selected operator is assigned as the delegate.

With reference to block 610, the method 600 may further include executing one or more functions for assigning the selected operator as a delegate with respect to the line. For example, an API call may be executed to assign the selected operator as a delegate.

With reference to block 612, the method 600 may further include linking the selected operator via an identifier (ID) to the role as a delegate on the line. The ID may be used to tag one or more actions taken by the operator while acting as a delegate. For example, the ID may be used to tag any messages that are sent or read by the operator while acting as a delegate. As such, other users may be able to identify actions that the operator took while acting as a delegate.

With reference to block 614, when the assignment of the selected operator as a delegate is completed, the operator is notified that he has been assigned as a delegate for the user of block 602. For example, an e-mail notification may be generated and sent to the newly assigned delegate.

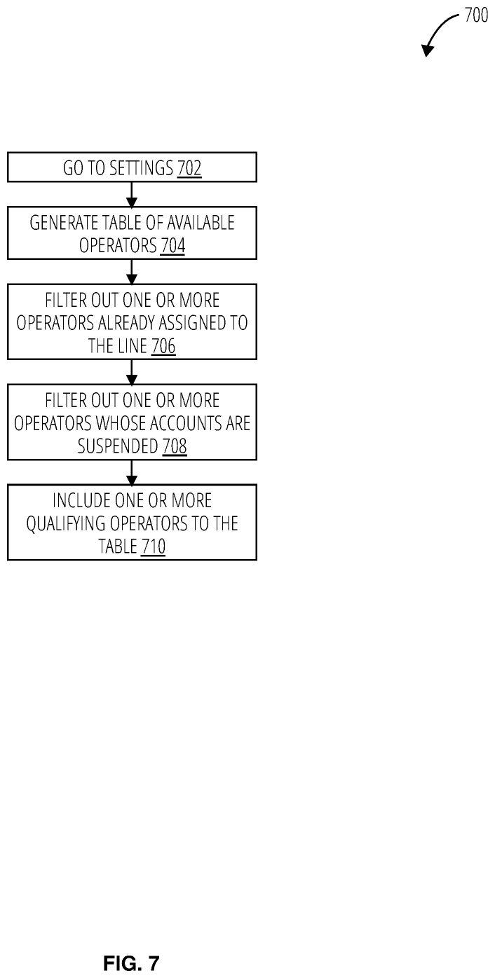

FIG. 7 is a flowchart of a method 700 for generating one or more menu items (e.g., a dropdown menu) to facilitate selection of an available operator as a delegate, according to at least one embodiment.

With reference to block 702, a user chooses to modify his user settings, which include assignation of a delegate to act on his behalf. For example, as illustrated in FIG. 5, the operator 510 chooses to assign a delegate as a part of his user settings.

With reference to block 704, a table view of operators is generated. The operators are deemed to be available for selection by the user as a delegate. The availability of a particular operator may be determined by one or more filters, as will be described in more detail with reference to block 706 and block 708.

With reference to block 706, one or more operators in the organization who are already assigned to the line are filtered out. For example, as illustrated in FIG. 5, the availability filter 512 filters out operators in the organization 502 who are already assigned to the line 522.

With reference to block 708, one or more operators in the organization whose accounts are suspended are filtered out. For example, as illustrated in FIG. 5, the permission filter 514 filters out operators in the organization 502 whose accounts (e.g., with respect to other lines in the organization 502) are not active due to being suspended.

With reference to block 710, one or more available operators are included in the generated table of block 704. For example, as illustrated in FIG. 5, a particular operator is determined to be available if the operator is successfully passed by the availability filter 512 and the permission filter 514. A listing of available operators may then be provided in the dropdown menu.

FIG. 8 illustrates a system 800 in which a server 804 and a client device 806 are connected to a network 802.

In various embodiments, the network 802 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 802 may also include a voice network that conveys not only voice communications, but also non-voice data such as Short Message Service (“SMS”) messages, as well as data communicated via various cellular data communication protocols, and the like.

In various embodiments, the client device 806 may include desktop PCs, mobile phones, laptops, tablets, wearable computers, or other computing devices that are capable of connecting to the network 802 and communicating with the server 804, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 804 and the client device 806 may be implemented via various combinations of physical and/or logical devices. However, it is not necessary to show such infrastructure and implementation details in FIG. 8 in order to describe an illustrative embodiment.

FIG. 9 is an example block diagram of a computing device 900 that may incorporate embodiments of the present invention. FIG. 9 is merely illustrative of a machine system to carry out aspects of the technical processes described herein, and does not limit the scope of the claims. One of ordinary skill in the art would recognize other variations, modifications, and alternatives. In one embodiment, the computing device 900 typically includes a monitor or graphical user interface 902, a data processing system 920, a communication network interface 912, input device(s) 908, output device(s) 906, and the like.

As depicted in FIG. 9, the data processing system 920 may include one or more processor(s) 904 that communicate with a number of peripheral devices via a bus subsystem 918. These peripheral devices may include input device(s) 908, output device(s) 906, communication network interface 912, and a storage subsystem, such as a volatile memory 910 and a nonvolatile memory 914.

The volatile memory 910 and/or the nonvolatile memory 914 may store computer-executable instructions and thus forming logic 922 that when applied to and executed by the processor(s) 904 implement embodiments of the processes disclosed herein.

The input device(s) 908 include devices and mechanisms for inputting information to the data processing system 920. These may include a keyboard, a keypad, a touch screen incorporated into the monitor or graphical user interface 902, audio input devices such as voice recognition systems, microphones, and other types of input devices. In various embodiments, the input device(s) 908 may be embodied as a computer mouse, a trackball, a track pad, a joystick, wireless remote, drawing tablet, voice command system, eye tracking system, and the like. The input device(s) 908 typically allow a user to select objects, icons, control areas, text and the like that appear on the monitor or graphical user interface 902 via a command such as a click of a button or the like.

The output device(s) 906 include devices and mechanisms for outputting information from the data processing system 920. These may include the monitor or graphical user interface 902, speakers, printers, infrared LEDs, and so on as well understood in the art.

The communication network interface 912 provides an interface to communication networks (e.g., communication network 916) and devices external to the data processing system 920. The communication network interface 912 may serve as an interface for receiving data from and transmitting data to other systems. Embodiments of the communication network interface 912 may include an Ethernet interface, a modem (telephone, satellite, cable, ISDN), (asynchronous) digital subscriber line (DSL), FireWire, USB, a wireless communication interface such as Bluetooth or Wi-Fi, a near field communication wireless interface, a cellular interface, and the like.

The communication network interface 912 may be coupled to the communication network 916 via an antenna, a cable, or the like. In some embodiments, the communication network interface 912 may be physically integrated on a circuit board of the data processing system 920, or in some cases may be implemented in software or firmware, such as “soft modems”, or the like.

The computing device 900 may include logic that enables communications over a network using protocols such as HTTP, TCP/IP, RTP/RTSP, IPX, UDP and the like.

The volatile memory 910 and the nonvolatile memory 914 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 910 and the nonvolatile memory 914 may be configured to store the basic programming and data constructs that provide the functionality of the disclosed processes and other embodiments thereof that fall within the scope of the present invention.

Logic 922 that implements embodiments of the present invention may be stored in the volatile memory 910 and/or the nonvolatile memory 914. Said logic 922 may be read from the volatile memory 910 and/or nonvolatile memory 914 and executed by the processor(s) 904. The volatile memory 910 and the nonvolatile memory 914 may also provide a repository for storing data used by the logic 922.

The volatile memory 910 and the nonvolatile memory 914 may include a number of memories including a main random-access memory (RAM) for storage of instructions and data during program execution and a read only memory (ROM) in which read-only non-transitory instructions are stored. The volatile memory 910 and the nonvolatile memory 914 may include a file storage subsystem providing persistent (non-volatile) storage for program and data files. The volatile memory 910 and the nonvolatile memory 914 may include removable storage systems, such as removable flash memory.

The bus subsystem 918 provides a mechanism for enabling the various components and subsystems of data processing system 920 communicate with each other as intended. Although the communication network interface 912 is depicted schematically as a single bus, some embodiments of the bus subsystem 918 may utilize multiple distinct busses.

It will be readily apparent to one of ordinary skill in the art that the computing device 900 may be a device such as a smartphone, a desktop computer, a laptop computer, a rack-mounted computer system, a computer server, or a tablet computer device. As commonly known in the art, the computing device 900 may be implemented as a collection of multiple networked computing devices. Further, the computing device 900 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method for accessing a communication line in a computer network by a delegate, the method comprising:
receiving, from a first user, a request for authentication of the user with respect to the line;
upon the authentication of the user being successful, controlling a user interface to display a plurality of users selectable as a delegate for the first user with respect to the line;
receiving, from the first user, a selection of a second user from among the plurality of users;
assigning the second user access to the line as the delegate for the first user, wherein the access to the line as the delegate for the first user is carried out exclusive of credentials information of the first user, thereby removing requirement of the first user to share the credentials information, and wherein the access to the line as the delegate for the first user grants at least permission to send messages or permission to receive messages on the line on behalf of the first user;
generating a notification to inform the second user of the assigning of the access to the line as the delegate for the first user; and
enabling the delegate to access the line based on the permissions.

2. The method of claim 1, wherein the first user is not assigned permission to perform one or more actions of an administrator with respect to the line.

3. The method of claim 1, wherein the plurality of users comprise users having permission to serve as the delegate for the first user.

4. The method of claim 3, wherein the users having permission to serve as the delegate for the first user exclude users already having access to the line.

5. The method of claim 3, wherein the users having permission to serve as the delegate for the first user exclude suspended users.

6. The method of claim 1, wherein the access to the line as the delegate for the first user grants fewer than all permissions granted to the first user.

7. The method of claim 6, wherein the access to the line as the delegate for the first user does not grant at least permission to modify settings of the first user.

8. The method of claim 1, wherein the access to the line as the delegate for the first user is configured such that one or more actions taken by the second user while acting as the delegate for the first user are tagged with a user identification of the second user.

9. The method of claim 1, wherein assigning the second user access to the line as the delegate for the first user comprises executing an application program interface (API) call.

10. The method of claim 1, wherein generating the notification comprises generating an e-mail notification.

11. A computing apparatus, the computing apparatus comprising:
a processor; and
a memory storing instructions that, when executed by the processor, configure the apparatus to:
receive, from a first user, a request for authentication of the user with respect to a line;
upon the authentication of the user being successful, control a user interface to display a plurality of users selectable as a delegate for the first user with respect to the line;
receive, from the first user, a selection of a second user from among the plurality of users;
assign the second user access to the line as the delegate for the first user, wherein the access to the line as the delegate for the first user is carried out exclusive of credentials information of the first user, thereby removing requirement of the first user to share the credentials information, and wherein the access to the line as the delegate for the first user grants at least permission to send messages or permission to receive messages on behalf of the first user;
generate a notification to inform the second user of the assigning of the access to the line as the delegate for the first user; and
enable the delegate to access the line based on the permissions.

12. The computing apparatus of claim 11, wherein the first user is not assigned permission to perform one or more actions of an administrator with respect to the line.

13. The computing apparatus of claim 11, wherein the plurality of users comprise users having permission to serve as the delegate for the first user.

14. The computing apparatus of claim 13, wherein the users having permission to serve as the delegate for the first user exclude users already having access to the line.

15. The computing apparatus of claim 13, wherein the users having permission to serve as the delegate for the first user exclude suspended users.

16. The computing apparatus of claim 11, wherein the access to the line as the delegate for the first user grants fewer than all permissions granted to the first user.

17. The computing apparatus of claim 16, wherein the access to the line as the delegate for the first user does not grant at least permission to modify settings of the first user.

18. The computing apparatus of claim 11, wherein the access to the line as the delegate for the first user is configured such that one or more actions taken by the second user while acting as the delegate for the first user are tagged with a user identification of the second user.

19. The computing of claim 11, wherein the instructions, when executed by the processor, configure the apparatus to assign the second user access to the line as the delegate for the first user by executing an application program interface (API) call.

20. The computing apparatus of claim 11, wherein the instructions, when executed by the processor, configure the apparatus to generate the notification by generating an e-mail notification.
